(19) United States
(12) Patent Application Publication
(10) Pub. No.: US 2008/0012713 A1
(43) Pub. Date: Jan. 17, 2008

(54) Method for Connecting a Bridge Module to a Substrate and Multi-Layer Transponder

(75) Inventor: Hans-Peter Monser, Dresden (DE)

Correspondence Address: NEEDLE & ROSENBERG, P.C., SUITE 1000, 999 PEACHTREE STREET, ATLANTA, GA, 30309-3915, US

(73) Assignee: Muhlbauer AG, Roding (DE)

(21) Appl. No.: 11/667,889

(22) PCT Filed: Oct. 28, 2005
(86) PCT No.: PCT/EP05/55622

§ 371 Date: May 16, 2007

(30) Foreign Application Priority Data
Nov. 18, 2004 (DE) 102004055616.4

(51) Int. Cl. G08B 13/14; H01Q 17/00; H01Q 7/00

(52) U.S. Cl. 340/572.8; 29/601; 343/700 MS

(57) ABSTRACT

The invention relates to a method for connecting a flat bridge module; for chip modules to a flat substrate having a flat antenna on its upper side, in order to form a multi-layer transponder, wherein the bridge module has electrically conductive connection surfaces, wherein, in order to form a mechanical connection, an electrically insulating adhesive is arranged as a layer between an underside of the bridge module on the one hand and parts of an upper side of the substrate and parts of an upper side of the antenna on the other hand and then, in order to form an electrical connection, an electrically conductive adhesive is applied to sections of the upper side of the antenna which protrude laterally with respect to the bridge module in such a way that the adhesive at least partially covers the edges of upper sides of the bridge module. A multi-layer transponder is shown.

The invention relates to a method for connecting a flat bridge module for chip modules to a flat substrate (1) having a flat antenna on its upper side, in order to form a multi-layer transponder, wherein the bridge module has electrically conductive connection surfaces, according to the preamble of claim 1. The invention also relates to a multi-layer transponder comprising at least one flat substrate, a flat antenna arranged thereon, and a flat bridge module which is arranged on the antenna and has electrically conductive connection surfaces, according to the preamble of claim 11.

The manufacture of smart labels and inlets as end products includes inter alia the arrangement of an RFID chip (Radio Frequency Identification chip), which is usually a silicon chip, on connection elements of an antenna and an antenna substrate which carries the antenna, in order to produce a transponder or a tag as an intermediate product. Such antenna substrates may be for example films, labels or inflexible plastic elements. Since the manufacture of smart labels has to take place in high numbers per unit time, not only the manufacturing speed but also the production costs associated with a mass-produced article are important factors for more efficient production of smart labels.

Silicon chips usually have small dimensions which lead to the use of so-called interposers or bridge modules, the function of which is to establish conductive connections in a bridge-like manner from the connection elements of the chip/chip module to the larger connection elements of the antenna on the antenna substrate. Here, both the bridge modules and the antenna substrate may be made from a wide range of materials.

One connection procedure for connecting the bridge modules to the antenna and the antenna substrate can be incorporated in a continuous production process for manufacturing a large number of transponders within a production device. In this case, each individual bridge module must be reliably connected both mechanically and electrically to its associated antenna, in order to establish an electrical contact between the chip and the antenna.

In order to effectively carry out such an assembly and contacting procedure within a continuous production process for a wide range of substrate, antenna and bridge module materials, use has thus far been made of a wide range of connection methods such as, for example, soldering, crimping, welding or adhesive bonding, depending on the materials used in each case. Here, the problem often arises that the connection means used either cannot be used for a continuous production process or cannot be used for a large number of different materials without impairing or reducing the durability of the connection.

In order to provide a connection between bridge modules and substrate and antenna when using a wide range of materials for almost any type of material combination, usually force-fitting and form-fitting types of connection are used, including riveting. However, this has the disadvantage that the consecutive production process must be used in each case on account of the force required here, and therefore no continuous process is possible. Furthermore, there is a need for additional elements, such as rivets, which lead to higher production costs.

From the adhesives sector, epoxy resin adhesives are known which are also suitable for connecting a wide range of metal materials and substrate materials to one another, at least mechanically. Furthermore, such adhesives can be made to be highly filled and electrically conductive, in order to establish an electrical connection. However, the epoxy resin adhesives used to date require relatively long curing times, which lead to a break in the desired continuous production process. Even more critical with such epoxy resin adhesives is their adhesive force which is not very durable when using untreated aluminium surfaces as the material for the components to be connected, as is often used for smart labels, since in this case an electrically insulating oxide surface is always present and thus no electrically conductive connection can be achieved.

The object of the present invention is therefore to provide a method for connecting a bridge module to a substrate having a flat antenna on its upper side, in order to form a multi-layer transponder, in which both a mechanical and a durable electrical connection for a wide range of bridge module, antenna and substrate materials can be achieved in a cost-effective manner and with a high throughput while maintaining a continuous production process during the production of a large number of transponders. A further object of the invention is to provide a multi-layer transponder in which the bridge module and the substrate and antenna can be connected to one another in a fast, simple and cost-effective manner, regardless of their material combinations.

This object is achieved in terms of the method by the features of claim 1 and in terms of the product by the features of claim 11.

The core concept of the invention is, in a method for connecting a flat bridge module for chip modules to a flat substrate having a flat antenna on its upper side, in order to form a multi-layer transponder, firstly, in order to form a mechanical connection, to arrange an electrically insulating adhesive as a layer between an underside of the bridge module on the one hand and parts of an upper side of the substrate and parts of an upper side of the antenna on the other hand and then, in order to form an electrical connection, to apply an electrically conductive adhesive to sections of the upper side of the antenna which protrude laterally with respect to the bridge module in such a way that the adhesive at least partially covers the edges of upper sides of the bridge module. In this way, a connection method which can be carried out rapidly is obtained since, in order to bring about firstly only a mechanical fixing of the bridge module to the substrate and the antenna, use can be made of an adhesive having properties which allow rapid curing, as is the case for example with hot-melt adhesives or previously applied adhesive films, and then usually arranging two small accumulations of electrically conductive adhesive on outer sides of connection surfaces of the bridge module which extend away to the left and to the right of the chip and on the protruding sections of the antenna, without applying any pressure. The curing of this electrically conductive adhesive can take place during the further transport of the transponder within the production device. No break in the continuous production process is thus required. Rather, as a result, it is possible to connect the bridge module and substrate and antenna so as to produce transponders with a high throughput.

Due to the separation between the electrically insulating adhesive for producing the mechanical connection and the electrically conductive adhesive for producing the electrical connection, it is possible to use suitable adhesives which are suitable for a wide range of material combinations of the substrate, antenna and bridge module materials and also the materials of their connection surfaces, even when using aluminium metallisations.

By applying the electrically conductive adhesive to the outer sides or edge regions of the bridge module and the laterally protruding antenna—and not just between the underside of the bridge module and the upper side of the antenna or substrate—a durable electrical connection is obtained since these are relatively small areas where the adhesive has been applied, which are less at risk of breakage when the transponder and in particular the bridge module is subjected to bending stress.

According to one preferred embodiment, the bridge module is composed of two layers and comprises a bridge module substrate and the electrically conductive, preferably metallic connection surfaces as metallisation layers. Such metallisation layers can be arranged on the upper side of the bridge module substrate. In this case, the electrically conductive adhesive is arranged on the upper side and end side of the metallisation layers such that it at least partially covers them at the edge, so that there is reliable contacting between the metallisation layer and the electrically conductive adhesive. Alternatively, the metallisation layers can be arranged on the underside of the bridge module substrate, as a result of which, depending on how far the metallisation layer extends in relation to the electrically conductive adhesive forming a layer, either contacting only at the end side or contacting at the end side and underside of the metallisation layers with the electrically conductive adhesive is achieved.

Instead of a two-layer structure of the bridge module, the bridge module may comprise a single metal layer as an interposer metal layer, which is covered in the edge region both on its upper side and end side by the electrically conductive adhesive.

The electrically conductive adhesive can be replaced by any type of electrically conductive paste or other such materials.

The curing of the electrically conductive adhesive during further transport can be accelerated by heating it. To this end, each transponder is passed through an oven during further transport or is moved past a radiant heat source or over a heat-conducting heated surface, in particular a heated plate.

As the electrically insulating adhesive, a hot-melt adhesive can be melted onto the underside of the bridge module and/or parts of the upper side of the substrate and the antenna and can be cooled within a predefinable time period, preferably of less than one second. There is therefore no need for the adhesive to be applied during a subsequent joining operation, meaning that a continuous production process is obtained.

During the joining operation, the bridge module or the interposer is briefly pressed with its underside against the upper sides of the substrate and parts of the antenna, while applying thermal energy. When the pressure is released, the temperature falls below the melting temperature of the hot-melt adhesive.

If the substrate material is paper, then instead of the hot-melt adhesive use is primarily made of pressure-sensitive adhesive films. Such adhesive films are laminated as a film onto the underside of the bridge module and/or parts of the upper side of the substrate and antenna prior to the joining operation. Alternatively, the pressure-sensitive adhesive may be applied as a liquid.

Metal surfaces or silver pastes may be used as the electrically conductive connection surfaces of the bridge module.

Further advantageous embodiments emerge from the dependent claims. Advantages and expedient features can be found in the following description in conjunction with the drawing, in which:

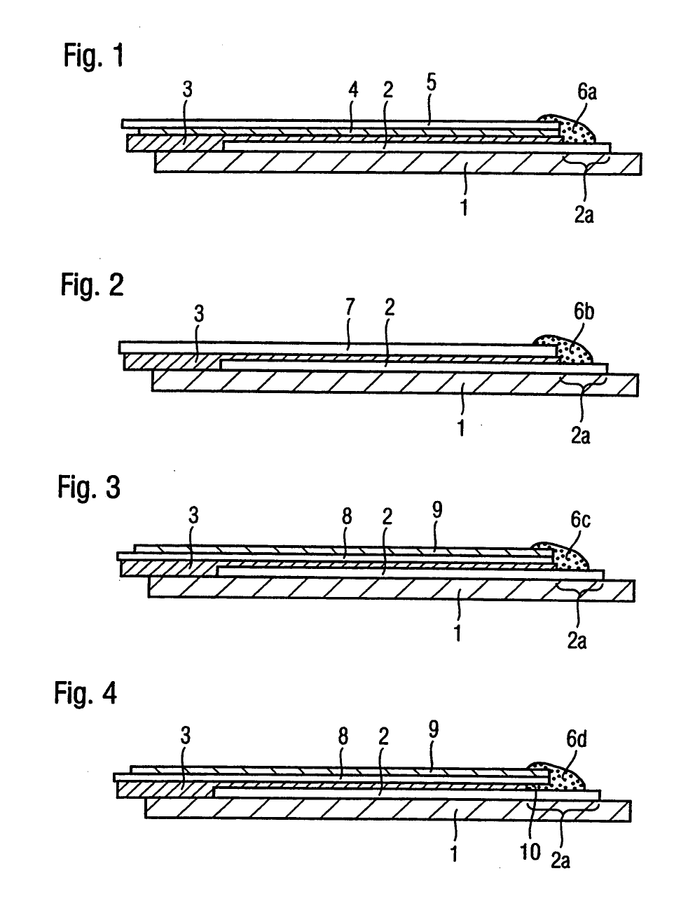

FIG. 1 shows a schematic cross-sectional diagram of part of a transponder, constructed and produced according to a first embodiment of the invention;

FIG. 2 shows a schematic cross-sectional diagram of part of a transponder, constructed and produced according to a second embodiment of the invention;

FIG. 3 shows a schematic cross-sectional diagram of part of a transponder, constructed and produced according to a third embodiment of the invention; and

FIG. 4 shows a schematic cross-sectional diagram of part of a transponder, constructed and produced according to a fourth embodiment of the invention.

FIG. 1 schematically shows part of the transponder constructed according to the invention, namely one of a total of two contact areas, according to a first embodiment. The multi-layer transponder consists of a preferably flat antenna substrate 1, an antenna 2 with its metallisation, a pressure-sensitive adhesive 3 as the electrically insulating adhesive which is applied as a layer both to an upper side of the antenna substrate 1 and the antenna 2, and the interposer or bridge module 4, 5.

The bridge module is composed of two layers and comprises an interposer substrate 4 and an interposer metallisation layer 5.

Unlike the electrically insulating adhesive 3, an electrically conductive adhesive 6a is arranged not as a layer between the layers but rather in the form of a bead in the edge region. To this end, the adhesive 6a contacts on the one hand protruding sections 2a of the antenna 2 and on the other hand the end side and at least the edges of the upper side of the metallisation layer 5 of the interposer. This permits a reliable and durable electrical connection between the bridge module and the antenna.

FIG. 2 shows a cross-sectional diagram of part of a multi-layer transponder according to a second embodiment. In all the figures, identical references are used for parts which are identical or which have the same function.

The transponder shown in FIG. 2 differs from the transponder shown in FIG. 1 in that the interposer is not composed of two layers but rather consists of a single-layer interposer metal layer 7. A conductive adhesive 6b once again covers the edges of the upper side of the interposer metal layer 7.

FIG. 3 shows a cross-sectional diagram of part of a transponder according to a third embodiment of the invention. The transponder shown in this figure differs from the aforementioned transponders in that, although the interposer is composed of two layers, an interposer metallisation layer 8 is arranged on an underside of an interposer substrate 9. A conductive adhesive 6c thus contacts the interposer metallisation layer only at its end side, but not on its upper side.

FIG. 4 shows a cross-sectional diagram of part of a transponder according to a fourth embodiment of the invention. The transponder shown in this figure differs from the transponder shown in FIG. 3 in that the electrically conductive adhesive 6d has an adhesive portion 10 which helps the adhesive 6d to cover the end sides of the entire interposer, i.e. the interposer substrate 9 and the interposer metallisation layer 8. This allows better and more durable contacting between the electrically conductive adhesive 6d and the interposer metallisation layer 8.

All the features disclosed in the application documents are claimed as essential to the invention in so far as they are novel individually or in combination with respect to the prior art.

### LIST OF REFERENCES

1 antenna substrate
2 antenna
2a protruding section of the antenna
3 pressure-sensitive adhesive layer
4, 9 interposer substrate
5, 8 interposer metallisation layer
6a, 6b, 6c, 6d electrically conductive adhesive
7 interposer metal layer
10 portion of the electrically conductive adhesive 6d

1. Method for connecting a flat bridge module for chip modules to a flat substrate having a flat antenna on its upper side, in order to form a multi-layer transponder, wherein the bridge module has electrically conductive connection surfaces, characterised in that, in order to form a mechanical connection, an electrically insulating adhesive is arranged as a layer between an underside of the bridge module on the one hand and parts of an upper side of the substrate and parts of an upper side of the antenna on the other hand and then, in order to form an electrical connection, an electrically conductive adhesive is applied to sections of the upper side of the antenna which protrude laterally with respect to the bridge module in such a way that the adhesive at least partially covers the edges of upper sides of the bridge module.

2. Method according to claim 1, characterised in that the electrically conductive adhesive contacts the electrically conductive connection surfaces of the bridge module at the edges of their upper sides.

3. Method according to claim 1, characterised in that the electrically conductive adhesive contacts the electrically conductive connection surfaces of the bridge module at their end faces.

4. Method according to claim 1, characterised in that the electrically conductive adhesive contacts the electrically conductive connection surfaces of the bridge module at the edges of their undersides.

5. Method according to claim 1, characterised in that the transponder is then heated for the accelerated curing of the applied electrically conductive adhesive.

6. Method according to claim 5, characterised in that the transponder passes through an oven in order to heat the electrically conductive adhesive.

7. Method according to claim 5, characterised in that the transponder passes a radiant heat source or a heat-conducting heated surface in order to heat the electrically conductive adhesive.

8. Method according to claim 1, characterised in that the electrically insulating adhesive as a hot-melt adhesive is melted onto the underside of the bridge module and/or parts of the upper side of the substrate and the antenna and is cooled within a predefinable time period.

9. Method according to claim 8, characterised in that the time period is less than one second.

10. Method according to claim 1, characterised in that the electrically insulating adhesive as a film is laminated onto the underside of the bridge module and/or parts of the upper side of the substrate and the antenna as a pressure-sensitive adhesive or hot-melt adhesive.

11. Multi-layer transponder, at least one flat substrate, a flat antenna arranged thereon, and a flat bridge module which is arranged on the antenna and has electrically conductive connection surfaces, characterised in that an electrically insulating adhesive is arranged as a layer between an underside of the bridge module on the one hand and parts of an upper side of the substrate and parts of an upper side of the antenna on the other hand, and an electrically conductive adhesive is applied to sections of the upper side of the antenna which protrude laterally with respect to the bridge module in such a way that the adhesive at least partially covers the edges of upper sides of the bridge module.

12. Transponder according to claim 11, characterised in that the bridge module is composed of two layers and comprises a bridge module substrate and the electrically conductive connection surfaces as metallisation layers.

13. Transponder according to claim 12, characterised in that the metallisation layers are arranged on the upper side of the bridge module substrate and are covered at least partially at the edges of their upper sides and end sides by the electrically conductive adhesive.

14. Transponder according to claim 12, characterised in that the metallisation layers are arranged on the underside of the bridge module substrate and are in contact at their end sides with the electrically conductive adhesive.

15. Transponder according to claim 14, characterised in that the electrically conductive adhesive covers the edges of the undersides and end sides of the metallisation layers.

16. Transponder according to claim 11, characterised in that the bridge module is a metal layer.
